(19) United States
(12) Patent Application Publication
(10) Pub. No.: US 2005/0214732 A1
(43) Pub. Date: Sep. 29, 2005

(54) Internet educational system combining teaching, academic affairs, and its method

(76) Inventors: Sayling Wen, Taipei (TW); Zechary Chang, Taipei (TW); Pinky Ma, Beijing (CN)

Correspondence Address: BIRCH STEWART KOLASCH & BIRCH, PO BOX 747, FALLS CHURCH, VA, 22040-0747, US

(21) Appl. No.: 10/806,224

(22) Filed: Mar. 23, 2004

(51) Int. Cl. G09B 3/00; G09B 25/00

(52) U.S. Cl. 434/350

(57) ABSTRACT

An Internet educational system combining teaching and academic affairs and its method, used to achieve course management and the related academic affairs. First, the member managing module authenticates the online members, verifies identifies of faculty and student, and displays faculty member list and all course information for student to schedule courses. Course managing module verifies the student's course schedule, lecturing module coordinates online teaching activity according to the course schedule, and evaluates learning grade simultaneously. The calculated learning grade is send to the grade managing module. It is then displayed to the student, and the student is allowed to choose the learning content and lecturing faculty at anytime, anywhere, and queries learning grade easily.

### BACKGROUND OF THE INVENTION

1. Field of Invention

The present invention relates to an Internet education system and its method, especially an Internet educational system that combines teaching, academic affairs, and its method.

2. Related Art

As communication technology advances, networks are used in all aspects of daily life. The development of network technology allows the implementation of an Internet teaching platform. Different kinds of remote education and Internet educational teaching structures are formed. Internet teaching provides individualized teaching service to students. It contains more information, faster and newer knowledge, and wider views; it compliments the shortcomings of the traditional education, and raises the students' self-motivation and enthusiasm.

Internet education has similarities with the traditional education; the basic models are both teaching and managing academic affairs. Traditional education's teaching is done in specified classrooms, and management uses a specific department in charge of managing academic affairs, the Academic Affairs Department. The department manages the limited faculties, students, funds, resource distribution and information to execute teaching plan managing, teaching operation managing, and teaching managing and evaluation. By comparing the Internet education and traditional education, the Internet education utilizes the teaching system to implement educational view, changed from the traditional view of focusing on the faculty to focusing on the student. Academic managing involves school, college, faculty, and student. As the educational system keeps on revaluating, especially in the course credit and course selecting academic affair systems, academic managing becomes more busy and complicated. By using an Internet academic system, it implements the management of faculty and student from limited space to unlimited space by using a computer system to change the managing method on students. Therefore, the academic affair system constructs the backbone of the Internet education. However, the known Internet educational system management either emphasizes on Internet teaching, or Internet academic management. These kinds of Internet education systems can only provide one-sided assistance to either the student or the faculty, which does not satisfy the needs of remote education. For example, after the teaching process is over, the student's grade has to be manually entered into the system for further processing.

Facing the development of interconnecting network, combined with the current development of the educational profession, to efficiently take advantage of the data resources in the interconnecting network for educational and scientific research purposes, the online resources can be fully utilized. This, to efficiently manage and service students scattered around the globe by using Internet technology to combine the unique service ability of the Internet with education purpose. These are topics that have been researched continuously.

### SUMMARY OF THE INVENTION

The invention is an Internet educational system combining teaching and academic affairs and its method that solves the described question. The main goals are to combine learning and academic affairs, to provide non-stop service, to utilize the vast information on the Internet, easy retrieving and saving, and interacting instantaneous learning and academic affairs managing with no time and space limitation. Students can choose the desired course content and lecturing faculty at anytime, anywhere, and can inquire a learning grade instantaneously.

Therefore, to achieve these goals, the Internet education system, combining learning and academic affair revealed by the invention, used to implement the course managing and related academic affairs managing between faculty and student, comprises of: a member managing module, using complete identity authentication and data inquiry for faculty and student, comprises of: a member managing module, using complete identity authentication and data inquiry for faculty and student. More, comprises of: a faculty managing unit, which stores a faculty member list that is used to complete faculty qualification authentication and record identity verification, and a student managing unit, which stores a student member list that is used to complete student enrollment registration and record the identification verification. a course managing module as well, providing course placement, verifies course selection information, and displays a faculty member list and course list to online students, which also comprises of: a course database, storing at least one set of course data, including text and a multimedia picture content, providing students with course selection and online teaching. A course scheduling module is involved as well, receiving course selection information from student and appointment with lecturing faculty, transmitting a selected course and faculty to mentioned course managing module for conflict verification, then transmitting mentioned verification result back to mentioned student; a lecturing module, according to student selected course information and lesson time, retrieving a corresponding lesson content from mentioned lesson database, also simultaneously connecting corresponding lecturing faculty and student online to execute a teaching activity During the lecture, mentioned lecturing faculty grades of mentioned student's learning process collects all grade statistics and obtains a learning grade for the current level; and a grade managing module, which is used to receive mentioned learning grade, and computes mentioned learning grade in different levels to a grade listing. Last, displaying and outputting mentioned grade list, so faculty and student can inquire mentioned learning grade instantaneously.

Also, the invention provides an Internet education method combining learning and academic affairs, used to implement lecturing management between faculty and student and related academic management. First, authenticate online members, verify faculty and student's identify; display a faculty member list and all course information. Students choose a course and lecturing faculty according to a lesson plan and schedules courses; verify student's said course schedule, and return the verification result. According to mentioned course schedule and mentioned verification result, the lesson plan executes an online learning activity, and also evaluates learning grades. Further, it collects statistics and calculates mentioned learning grades and displays the result to the student.

According to the invention's Internet education system and its method combined learning and academic affair and utilizing Internet to execute online academic affair managing and different kinds of online lecturing activity, different kinds of learning, such as role-playing, independent learning, etc, can be executed. The invention also provides multiple interactions and discussions that break the time and space barrier, so people can choose the desired course content, lecturing faculty anytime, anywhere, and also inquire learning grades conveniently. Therefore, Internet education evolves from a simple learning information distributor to a highly interactive virtual community.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus is not limitative of the present invention, wherein:

FIG. 1 illustrates the structure of the modules of the Internet educational system, combining teaching and academic affairs.

FIG. 2 illustrates the flow of the Internet educational system, combining teaching and academic affairs.

FIG. 3 illustrates the flow of the member identification authentication.

FIG. 4 illustrates the flow of the grade inquiry.

FIG. 5-a to 5-g illustrates the embodiment of the invention's interfaces.

### DETAILED DESCRIPTION OF THE INVENTION

Internet education can allow students to utilize the tremendous amount of information available, the ease of retrieving and saving, and instantaneous learning and researching. It also implements centralized management, decentralized operation, and data sharing for the academic affairs, so the traditional academic affair management is evolving towards digital, intellectual, total integration. This builds a better function for implementing a complete computer academic affair management system. Internet academic affairs need to contain better interaction and instant-ness, to ensure smooth operation of Internet teaching, and provide better teaching quality. Teaching and academic affairs management also needs to emphasize on people first and has to be service oriented.

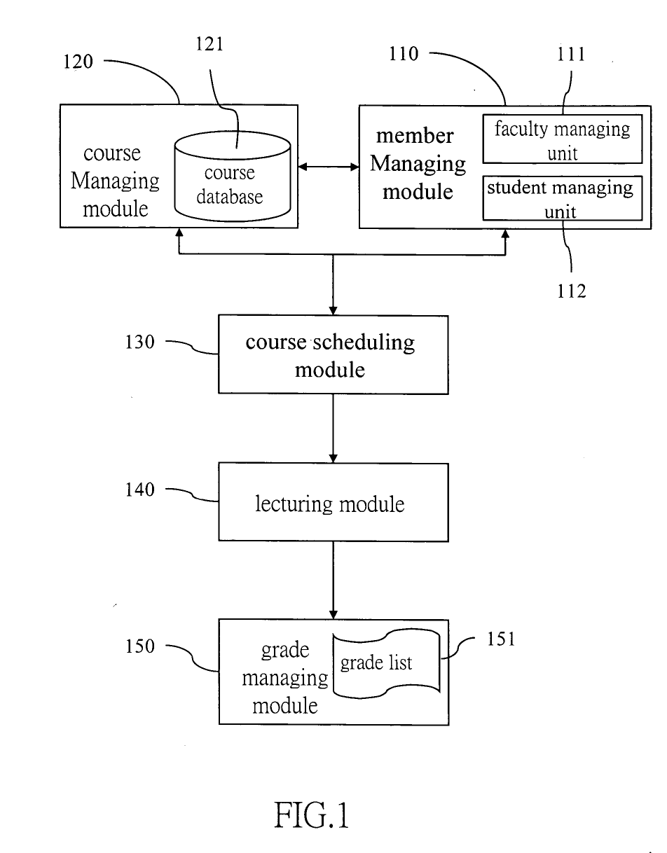

The invention is an Internet educational system combining teaching and academic affairs and its method, to implement the management of teaching and academic affairs between faculty and student. First, FIG. 1 illustrates the invented system; it is the structure of the Internet educational system, combining teaching management and academic affairs management. Member management module 110 is the entrance of the system; it comprises of a faculty managing unit 111 and a student managing unit 112. Course managing 120 comprises of a course database 121, which is connected to the course schedule module 130. Lecture module 140 is connected to all other modules. All members passing identification authentication can execute Internet teaching activities, using the lecture module's voice frequency and video frequency module, and the learning grade is transmitted to the grade list 151 in the grade managing module 150 for display. The detailed explanation of the invented system is the following:

1). Member managing module 110, used to complete the identification authentication for the faculties and students; it comprises of faculty managing unit 111 and student managing unit 111. The faculty managing unit 111 has a faculty member list, used to complete the faculty qualification verification, and record identification authentication. The faculty list also stores faculty data, comprising name, sex, located city, brief biography, rating, online condition, and appointment schedule, used for students acquisition when registering for classes. The student managing unit 112 stores a student member list, used to complete the grade registration, record identification authentication, and data searching. All faculties and students passing the authentication also contain a password generation, change, and request function.

2). Course managing module 120, which is used to provide placement and checking course selection information. It displays the faculty member list and course listing to online students. It also comprises of course database 121, which stores at least one course data, including a text and multimedia picture content, for student's course selection and online teaching.

3). Course schedule module 130 is used to receive the student's course selection information and make appointments with the lecturing faculty. The selected course and faculty is uploaded to mentioned course managing module for complication checking, then the result is send back to the student. The course schedule module transmits the student course selection result back to the lecturing faculty, so the lecturing faculty knows the course selection result to prepare the course. It can also provide faculty online, receiving the student course selection information, to execute a course conflict check, and sends back the result of the check to the student.

4). Lecture module 140, use the selected course data by the student and the course time to retrieve the corresponding course content from the course database. It also connects the corresponding lecturing faculty and students online; it connects the voice and video frequency modules between the lecturing faculty and student to execute the teaching operation. During the lecture, the lecturing faculty can evaluate the student's learning instantaneously. By calculating all the evaluation grades, the grade for the current learning level can be obtained. The lecture module transmits the current course content to the faculty and students simultaneously, allowing interactive teaching, focusing on the corresponding course topic.

5). Grade managing module 150, used to receive mentioned learning grade, and calculating mentioned learning grade in different levels. It also displays the grade list 151, so both the faculty and student can instantaneously search mentioned learning grade.

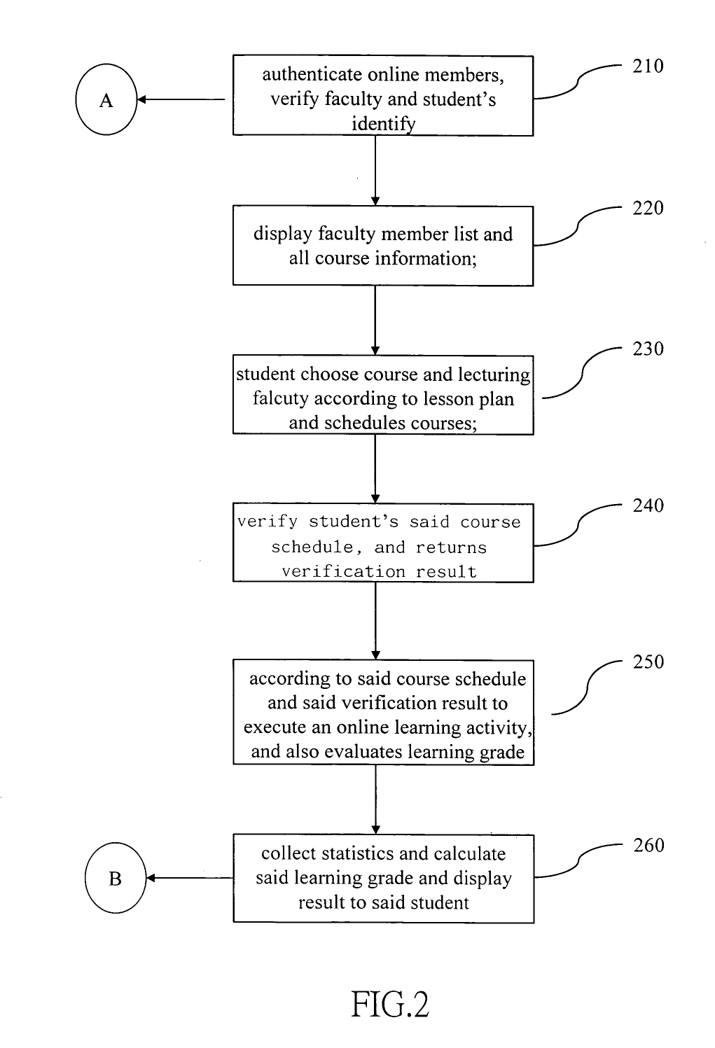

Next, using FIG. 2 to illustrate the flow of the invention; it illustrates in flow diagram form, the Internet educational method teaching and academic affairs, the detailed explanation is as follows

First, authenticates the online members, verifies the identification of the faculty and student (step 210), and then displays the faculty member list and all course information (step 220). The student selects the courses and lecturing faculty according to the course plan, and selects a course schedule (step 230). The system verifies the student's course schedule and returns the results of inspection (step 240) According to the course schedule and the result of the inspection, it executes online teaching activity. It also evaluates and gives learning grades simultaneously (step 250), calculates the learning grades and displays it to the student (step 260).

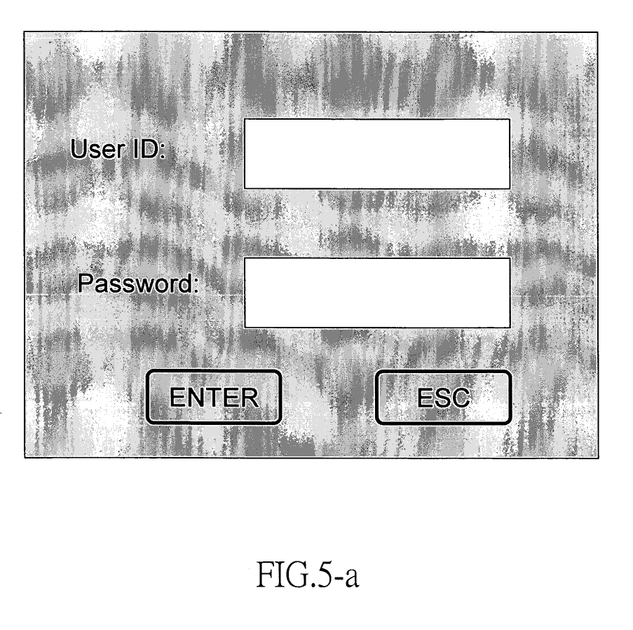

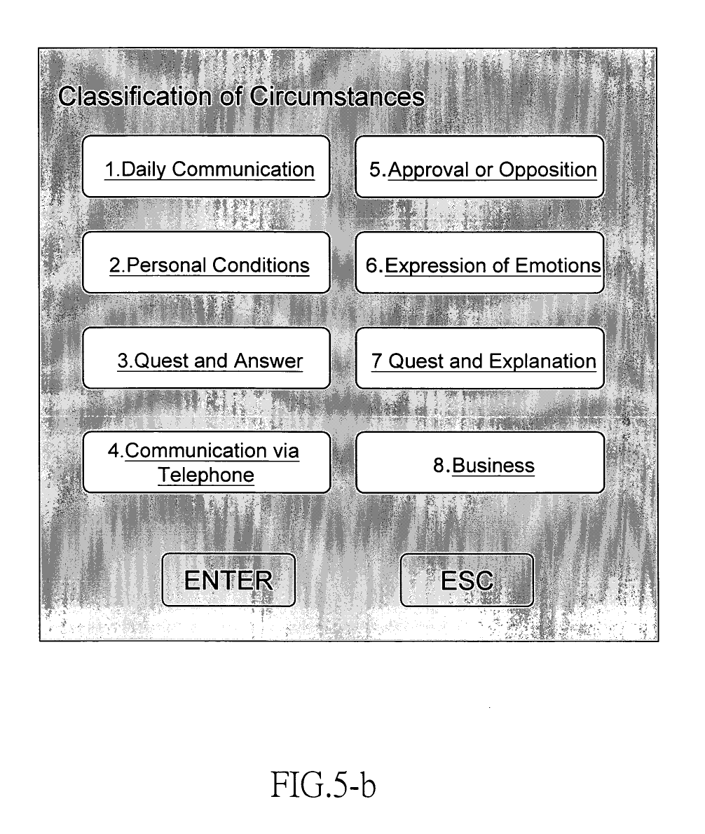

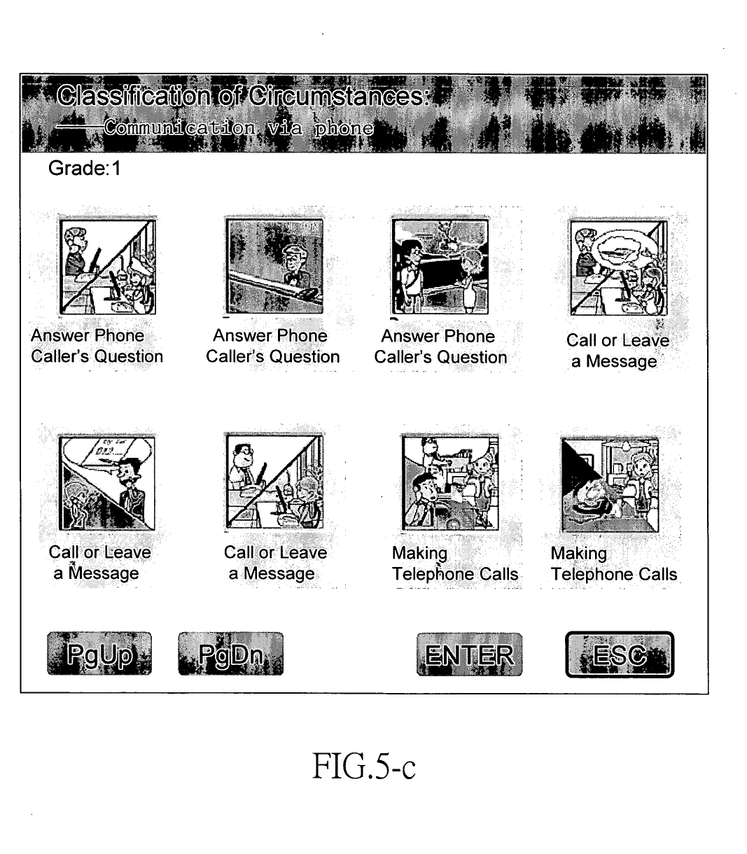

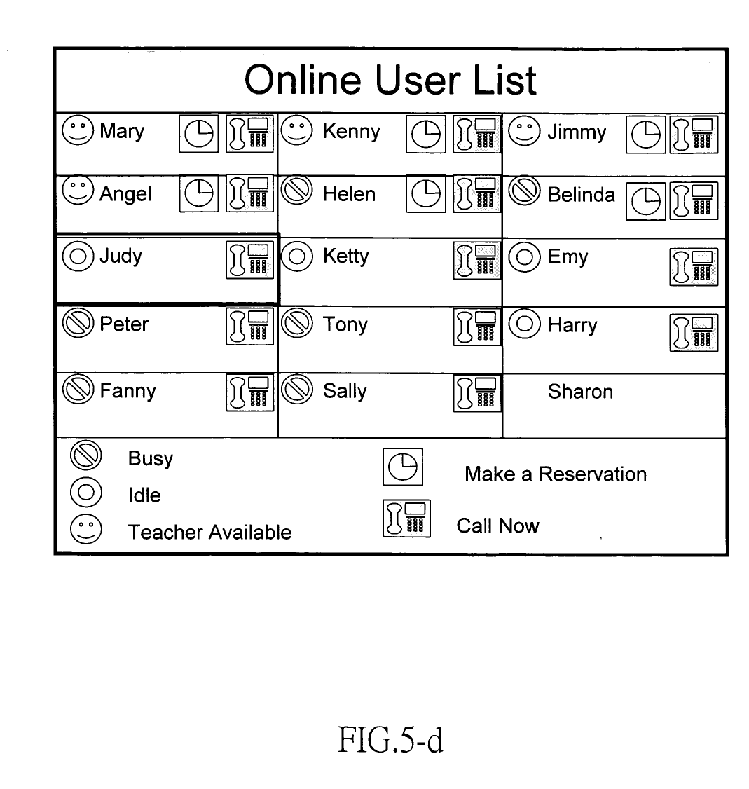

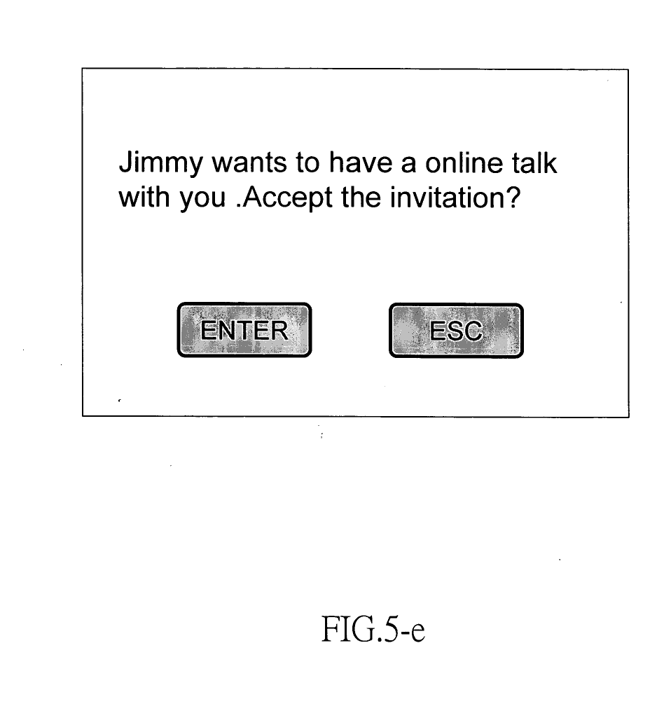

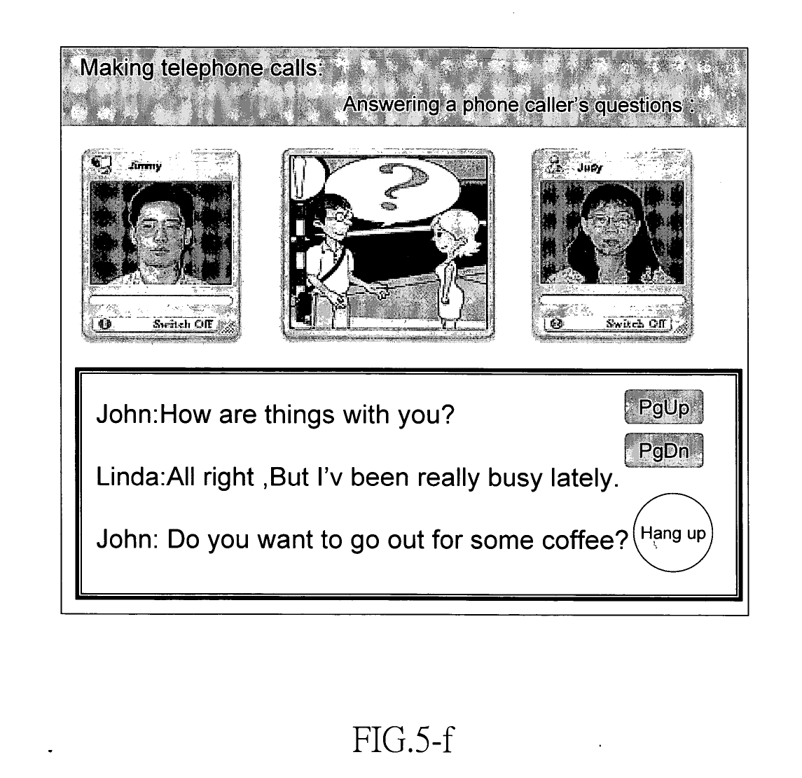

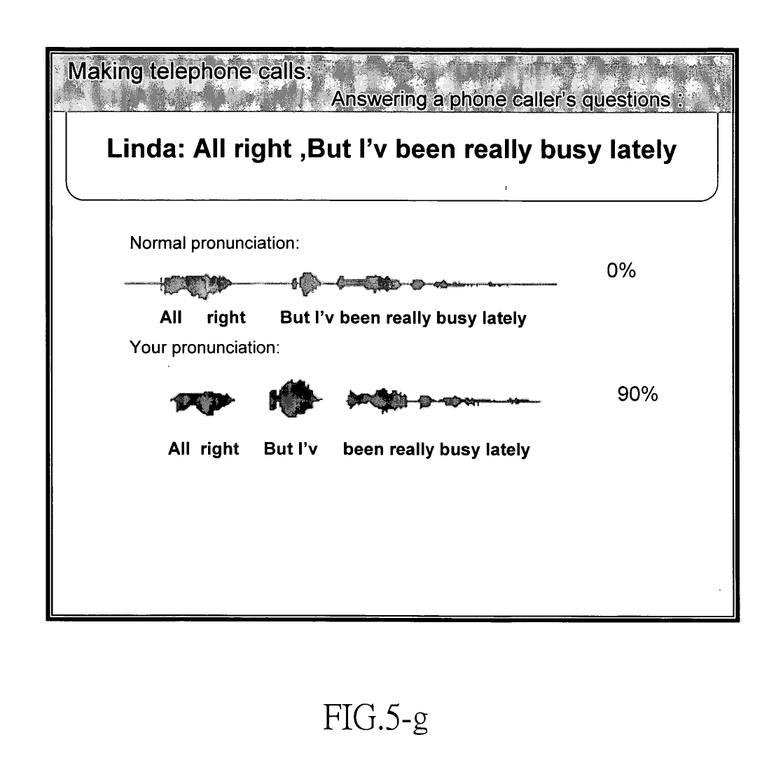

The following is an example of an online verbal education method, combining with the embodiment's interface illustration on FIG. 5-a to FIG. 5-g, for a detailed explanation of the invention.

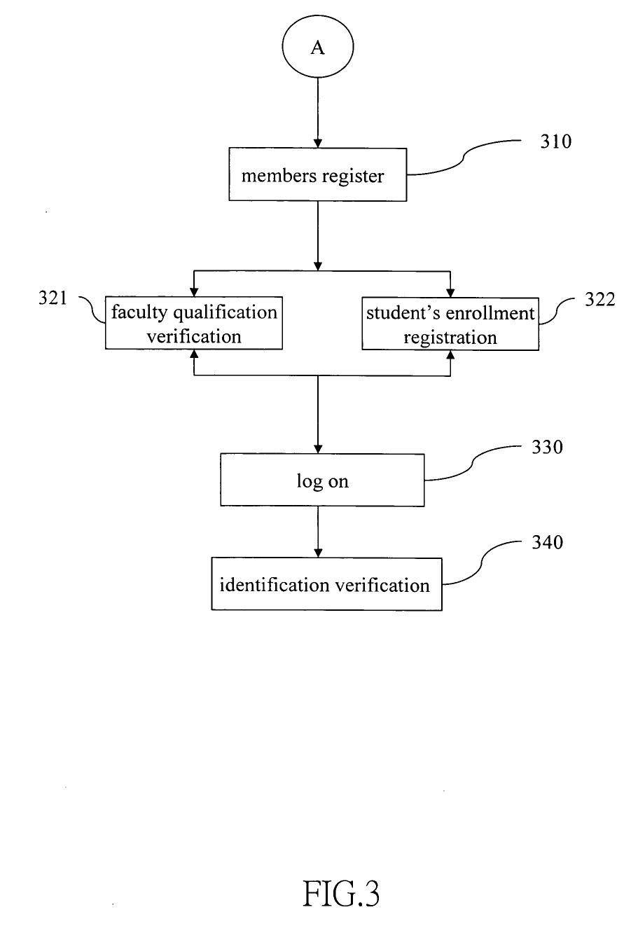

Please refer to FIG. 3, which illustrates the flow of member identification authentication. First, the members register online (step 310), which includes faculty qualification verification (step 321) and student's enrollment registration (step 322). All registered members receive a user number, and use mentioned user number in combination with the pre-set password to log on (step 330). The system uses the user number for identification verification (step 340), and stores them into the online faculty list or online student list. Then the online student executes course scheduling, including selecting course data, lecturing faculty, and schedule course time. Please refer to FIG. 5-b, students use the interfaces shown in the picture to execute course selection. They can also choose, as shown in FIG. 5-c, the system displays all course information.

The student completes the course selection and then the system displays the faculty member list, please refer to FIG. 5-e, the picture illustrates the interface of selected faculty member. IT displays the online condition of the whole faculty, red indicates a faculty engaged in a conversation, green indicates a faculty witch is free and waiting for connection, and blue is a connectable faculty member. The student can use the online condition of the faculty to select the lecturing faculty. The system can also display the faculty data in further detail, as shown in the following chart. Chart 1 is the faculty member list.

Chart 1 :

| Identity | Name | Sex | Located City | Rating | Condition | | |
|---|---|---|---|---|---|---|---|
| Faculty | XXX | F | New York (USA) | **** | B Course detail | Appointment | Connect |
| Faculty | YYY | M | L.A. (USA) | ***** | Y Course detail | Appointment | Connect |
| Faculty | RRR | F | L.A. (USA) | ***** | N Course detail | Appointment | Connect |

The faculty member list includes data such as the faculty's name, sec, located city, brief biography, ratings, online condition, and appointment status. Students can choose the course and lecturing faculty according to the lesson plan, to schedule the courses. As the online faculty receives the course schedule of the student, displayed in the interface shown in FIG. 5e, he/she checks the course schedule for conflicts, verifies if he/she is free at the student scheduled time, and sends back the results of the verification. If a conflict is found as the verification result, it tells the student to reschedule the courses. If the verification result does not find a conflict, it sends verified data. When the faculty is not online, the system can also execute the conflict verification. The system uses the course schedule provided by the student and the course schedule list provided by the faculty for verification and also returns the verification result back to the student, and the corresponding faculty's course schedule list. The faculty can receive the scheduled course, when logged on to the system. According to the scheduled course, an online teaching activity is executed; the online activity is shown in FIG. 5-f, using voice and video frequency for interacting lecture. The learning grade is also evaluated during the lecture; the student is evaluated as the learning quality is quantified, as shown in FIG. 5g. The system receives the voice frequency data inputted by the student, and compares it with the content of the course data, to obtain the evaluation signal. The evaluation signal is transmitted back to the grade managing system. Chart 2 is the student learning evaluation chart.

Chart 2 :

| | | Grade level | | | |
|---|---|---|---|---|---|
| No. | Category | A | B | C | D |
| 1 | Listening | No need for | Sometimes need | Often need to | Cannot |
| | | repeating | repeating | repeating | understand |
| 2 | Pronunciation | Very accurate | Basically accurate | Can be guessed | Cannot |
| | | | | | understand |
| 3 | Fluency | Very fluent | Pause sometimes | Pause often | No fluency |
| 4 | Standardization | Very accurate | Basically correct, | More mistakes | Cannot |
| | | | little mistake | than usual | understand |
| | | | sometimes | | |
| 5 | Creativity | Lots of variety | Often has variety | Sometimes has | No creativity |
| | | | | variety | |
| 6 | Reaction | Fast | Faster than normal | Normal | Slower than |
| | | | | | normal |
| 7 | Intonation | Good usage | Use often | Use occasionally | No usage |
| 8 | Vocabulary | Vast vocabulary | Understand more | Limited | Cannot |
| | | | | vocabulary | communicate |

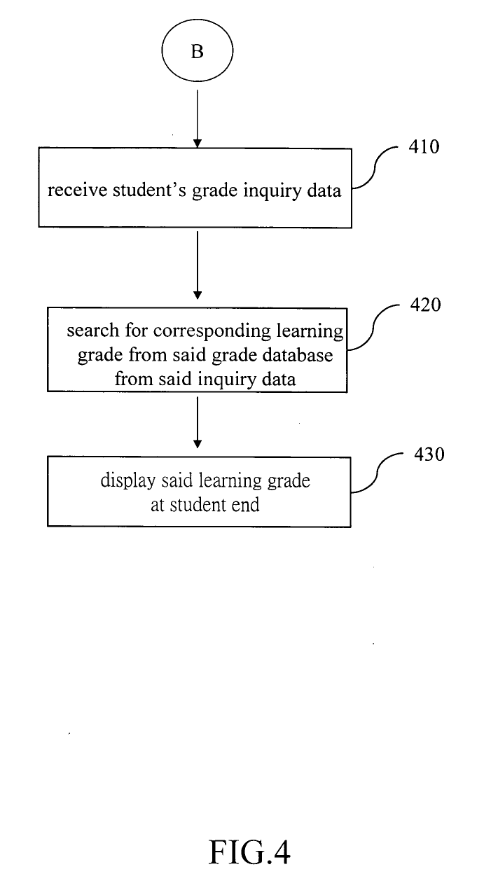

The system gathers the statistics of the student's learning grade and displays to the student. The student can ask for the learning grade, please refer to FIG. 4 for the grade query flow diagram. First, a query from the student is received (step 410), and the corresponding learning grade according to the query data is searched in the grade database (step 420), finally displays the grade on the student's end (step 430).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A Internet educational system combining learning and academic affair, used to implement the lesson managing and the related academic affair managing between faculty and students, comprises of:
a member managing module, used complete identity authentication and data inquiry for faculty and student, comprises of:
a faculty managing unit, which stores a faculty member list that is used to complete faculty qualification authentication and record identity verification; and
a student managing unit, which stores a student member list that is used to complete student enrollment registration and record the identification verification;
a course managing module, which provides course placement, verifies course selection information, and displays faculty member list and course list to online students, which also comprises of:
a course database, which stores at least one course data, including text and multimedia picture content, provides students for course selection and online teaching;
a course scheduling module, which receives course selection information from student and appointment with lecturing faculty, transmits selected course and faculty to said course managing module for conflict verification, then transmits said verification result back to said student;
a lecturing module, according to student selected course information and lesson time, retrieves corresponding lesson content from said lesson database, also simultaneously connect corresponding lecturing faculty and student online to execute a teaching activity, during lecture, said lecturing faculty grades said student's learning process instantaneously, collect all grade statistics and obtains learning grade for current level; and
a grade managing module, which is used to receive said learning grade, and computes said learning grade in different levels to a grade listing, display and output said grade list, so faculty and student can inquire said learning grade instantaneously.

2. The Internet education system combining teaching and academic affair as described in claim 1, wherein said faculty managing unit also comprises of faculty who passes qualification authentication implement password generation, change, and inquiry functions.

3. The Internet education system combining teaching and academic affair as described in claim 1, wherein said student managing unit also comprises of student passing enrollment registration implement password generation, change, and inquiry functions.

4. The Internet education system combining teaching and academic affair as described in claim 1, wherein said faculty member list comprises of faculty's name, sex, located city, brief biography, rating, online condition, and appointment status.

5. The Internet education system combining teaching and academic affair as described in claim 1, wherein said lesson scheduling module also comprises of providing faculty online receiving student's course selection information for conflict check, and transmits check result back to student.

6. The Internet education system combining teaching and academic affair as described in claim 1, wherein said course scheduling module transmits student's course selection result to corresponding lecturing faculty, so said lecturing faculty can execute lesson preparation after obtaining course selection result.

7. The Internet education system combining teaching and academic affair as described in claim 1, wherein said lecturing module constructs Internet connection between lecturing faculty and student is to connect voice and video frequency between lecturing faculty and student.

8. The Internet education system combining teaching and academic affair as described in claim 1, wherein said lecturing module transmits current course content simultaneously to said faculty and student, allowing interactive teaching focusing on corresponding lesson topic.

9. A Internet education method combining learning and academic affair, used to implement lecturing management between faculty and student and related academic management, at least comprises of the following steps:
authenticate online members, verify faculty and student's identify;
display faculty member list and all course information;
student choose course and lecturing falcuty according to lesson plan and schedules courses;
verify student's said course schedule, and returns verification result;
according to said course schedule and said verification result to execute an online learning activity, and also evaluates learning grade; and
collect statistics and calculate said learning grade and display result to said student.

10. The Internet education method combining teaching and academic affair as described in claim 9, wherein said step of authentication of online member, verify said faculty and student identity also comprises of:
faculty execute qualification evaluation and records identity verfication; and
student execute enrollment registration and records identity verification.

11. The Internet education method combining teaching and academic affair as described in claim 9, wherein said faculty member list comprises of faculty's name, sex, located city, brief biography, rating, online condition, and appointment status.

12. The Internet education method combining teaching and academic affair as described in claim 9, wherein said step of verifying student's said course schedule, and return verification result, is corresponding faculty online verifying student's course schedule and return verification result.

13. The Internet education method combining teaching and academic affair as described in claim 9, wherein said step of verifying student's said course schedule and return verification result, is system verifying student's course schedule and return the verification result back to said student and corresponding faculty.

14. The Internet education method combining teaching and academic affair as described in claim 9, wherein said step of verifying student's said course schedule and return verification result, if there is conflict in verification result, it reminds student to restart course scheduling.

15. The Internet education method combining teaching and academic affair as described in claim 9, wherein said online teaching activity is an interactive teaching activity using voice and video frequency.

16. The Internet education method combining teaching and academic affair as described in claim 9, wherein said step of displaying learning grade to said student also comprises of:
receive student's grade inquiry data;
search for corresponding learning grade from said grade database from said inquiry data; and
display said learning grade at student end.
